(19) United States
(12) Patent Application Publication
(10) Pub. No.: US 2005/0071875 A1
(43) Pub. Date: Mar. 31, 2005

(54) Programmable electronic program guide

(76) Inventor: Mark S. Kempisty, Richboro, PA (US)

Correspondence Address: RATNERPRESTIA, P O BOX 980, VALLEY FORGE, PA, 19482-0980, US

(21) Appl. No.: 10/671,402

(22) Filed: Sep. 25, 2003

(51) Int. Cl. H04N 5/445; G06F 3/00; G06F 13/00

(52) U.S. Cl. 725/56; 725/39

(57) ABSTRACT

A method, system, and apparatus for configuring an electronic program guide controller is disclosed. The electronic program guide controller is capable of generating a grid pattern for display on a display device. The grid pattern contains program cells having associated lengths and includes one or more rows and a plurality of columns. Each row corresponds to a program channel and each column represents a predefined period of time. Program cells with lengths exceeding the predefined period of time span multiple columns. The electronic program guide controller is configured in one of at least two time shift modes responsive to instructions received from a user and shifts the grid pattern time focus in accordance with the configured time shift mode responsive to shift instructions received from the user. The modes include a column time shift mode, a program time shift mode, and a user defined time period shift mode.

### FIELD OF THE INVENTION

This present invention relates to electronic program guides and, more particularly, the methods, systems, and apparatus for customizing an electronic program guide for a television receiver based on user preferences.

### BACKGROUND OF THE INVENTION

Electronic program guides (EPGs) are currently available that contain content such as television schedule information for most television sources, e.g., broadcast, cable, and satellite. An EPG is typically transmitted during a Vertical Blanking Interval (VBI) of an NTSC television signal or on a separate channel, e.g., an out-of-band channel or a digital data channel. Presently, many television receivers, such as those found in set-top boxes or televisions, are able to receive and decode the transmitted EPG for visual presentation on a video display associated with the television receiver.

EPGs are generally presented to television viewers in a grid format having a fixed number of rows and columns. Each row corresponds to a television channel and each column corresponds to a fixed period of time, e.g., one-half hour. The grid includes a plurality of cells in which each cell represents a program (referred to herein as a “program cell”). The size of each program cell (i.e., the cell width) represents the length of the program (spanning one or more columns). The EPG is typically capable of displaying a fixed number of columns, e.g., three half-hour columns, that represent a “window of time,” e.g., an hour and a half for three half-hour columns. When the EPG is initially accessed, the window of time extends from the current time. To select a particular program within the window of time, a television viewer may use keys and/or buttons on a control device, e.g., arrow keys, to navigate a cursor to a specific row and column corresponding to that program and, then, press a selection key, e.g., an enter key, to access or obtain additional information.

Typically, to navigate to program schedule information of programs not in the displayed window of time, television viewers use keys and/or buttons of the control device, e.g., arrow keys, to change the window of time. For example, a right arrow key may shift the window of time forward and a left arrow key may shift the window of time backward. In some EPGs, each arrow press moves the window of time one column at a time. In these EPGs, if each column represents a half-hour, each arrow press shifts the window of time a half-hour in a corresponding direction. This method of changing the window of time is particularly cumbersome if the television viewer mainly watches movies, which typically span several columns. Thus, to determine the next movie following a current movie, the television viewer must press an arrow key several times to move through the columns corresponding to the current movie. For example, a current movie of three hours necessitates six presses of the arrow key to reach the next movie.

In other EPGs, each arrow press shifts the window of time to a time period corresponding to the next available program in a row on which the cursor is positioned. In these EPGs, a viewer selects the appropriate row (i.e., channel) and then shifts the window of time relative to the programs on that channel. Thus, if a program spans multiple columns, a single key press moves the window of time multiple columns. This results in abrupt changes to the programs displayed in adjacent rows (assuming these programs have a shorter duration). Some viewer are disoriented by these abrupt changes, thereby reducing these viewer's acceptance of this type of EPG.

Accordingly, EPGs are needed that address the above limitations. The present invention fulfills this need among others.

### SUMMARY OF THE INVENTION

The present invention includes a method, system, and apparatus for configuring an electronic program guide controller. The electronic program guide controller is capable of generating a grid pattern for display on a display device. The grid pattern contains program cells having associated lengths and includes a plurality of columns. Each column represents a predefined period of time. Program cells with lengths exceeding the predefined period of time span multiple columns.

The method includes receiving instructions of a user at the electronic program guide controller and configuring the electronic program guide controller in one of at least two time shift modes responsive to the received instructions. The method may be implemented in software embodied in a computer readable medium.

The system includes means for configuring an electronic program guide controller capable of being configured in at least two time shift modes responsive to a configuration signal and means for generating the configuration signal responsive to user instructions to selecting one of the at least two time shift modes.

The apparatus includes a controller and an on-screen display processor. The controller receives instructions of a user to select one of at least two time shift modes to shift the time focus of the grid pattern. The controller is configured to receive the electronic program guide signal, to generate the grid pattern from the electronic program guide signal, and to shift the time focus of the grid pattern responsive to user shift instructions in accordance with the selected one of the at least two time shift modes. The on-screen display processor is coupled between the controller and the display device and is configured to provide the generated grid pattern as a video signal to the display device.

### BRIEF DESCRIPTION OF THE DRAWINGS

The invention is best understood from the following detailed description when read in connection with the accompanying drawings, with like elements having the same reference numerals. This emphasizes that according to common practice, the various features of the drawings are not drawn to scale. On the contrary, the dimensions of the various features are arbitrarily expanded or reduced for clarity. Included in the drawings are the following features:

FIG. 1 is a block diagram of a video system for configuring an EPG controller in accordance with the present invention;

FIG. 2 is an illustration of a displayed portion of an EPG in accordance with the present invention;

FIG. 3 is a flow chart depicting an exemplary method for configuring an EPG controller in a time shift mode in accordance with the present invention; and

FIG. 4 is a flow chart depicting an exemplary method for shifting the time focus of an EPG in accordance with the time shift mode in which an EPG controller is configured in FIG. 3.

### DETAILED DESCRIPTION OF THE INVENTION

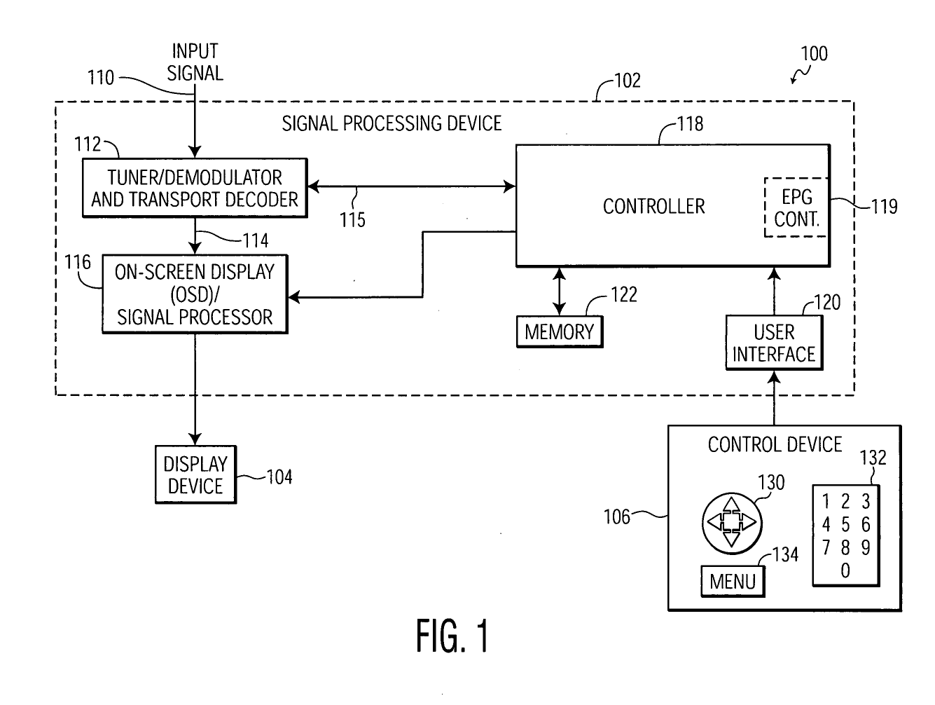

FIG. 1 depicts an exemplary embodiment of a video system 100 in accordance with the present invention. The illustrated system 100 includes a signal processing device 102, a display device 104 (e.g., a television monitor), and a control device 106. The signal processing device 102 is configurable for use with the display device 104. In exemplary embodiments, the signal processing device 102 is implemented in an integrated receiver/decoder (IRD) contained within a television receiver or a set-top box (not shown), which may contain additional circuitry, configured for use with a television receiver or a television monitor.

In the illustrated signal processing device 102, an input signal 110 is applied to a tuner/demodulator and transport decoder 112. In an exemplary embodiment, the input signal includes a program signal and an EPG signal. The tuner/demodulator and transport decoder 112 tunes, demodulates, and decodes the input signal 110 to yield the program signal 114 and the EPG signal 115. In the illustrated embodiment, the tuner/demodulator and transport decoder 112 provides the program signal 114 to an on-screen display (OSD)/signal processor 116 and the EPG signal 115 to a controller 118. A detailed description of a tuner/demodulator and a transport decoder, and their associated functions, is present in U.S. patent application Publication (Pub. No.: US 2002/0194596 A1) entitled CONTROL OF MULTIPLE AV-DEVICES BY A SINGLE MASTER CONTROLLER USING INFRARED TRANSMITTED COMMANDS AND BUS TRANSMITTED COMMANDS.

The OSD/signal processor 116 processes the program signal 114 for presentation by the display device 104. The OSD/television signal processor 116 may be a conventional analog or digital television signal processing system, including circuits for decoding and processing both audio and video components of the program signal 114, coupled to a conventional OSD processor. In an exemplary embodiment, the OSD/signal processor 116 is configured to provide a grid pattern (described below) generated by the controller 116 as a video signal to the display device 104. In certain exemplary embodiments, the display device 104 is a conventional display device, such as television monitor or projector, that presents the video signals received from the OSD/signal processor 116.

The controller 118 controls the tuner/demodulator 112 and the OSD/signal processor 116. In addition, the controller 118 is configured to receive the EPG signal 115, generate the grid pattern from the EPG signal 115, and pass portions of the EPG to the OSD/signal processor 116. Thus, in the illustrated embodiment, the controller 118 is an EPG controller. In alternative embodiments the EPG is extracted and passed by a separate controller (not shown), alone or in conjunction with the controller 118, which receives the EPG signal 115 and generates the grid pattern. In accordance with exemplary embodiments of the present invention, user instructions received through a user interface 120 determine the manner in which the EPG controller (e.g., controller 118) responds to user instructions to shift the time focus of the grid pattern, which is described in detail below. The controller 118 is coupled to a conventional memory 122. A suitable controller 118 for use in the present invention will be readily apparent to those of skill in the art of television signal processing.

The user interface 120 provides an interface between the controller 118 and the control device 106. The user interface 120 communicates with the control device 106 using wired and/or wireless communication systems such as infrared (IR) or radio frequency (RF) communication systems. A suitable user interface will be readily apparent to those of skill in the art of television signal processing.

The illustrated control device 106 includes an arrow control 130, a keypad 132, and a menu key 134. In an exemplary embodiment, the control device 106 generates and processes signals for communication from the control device 106 to the user interface 120 of the signal processing device 102. The signals are communicated to the signal processing device using a wired connection or a wireless medium such as infrared (IR) or radio frequency (RF) mediums. In an exemplary embodiment, the arrow control 130, keypad 132, and menu key 134 are conventional control keys/buttons typically found on a remote control device. A suitable control device 106 for use in the present invention will be readily apparent to those of skill in the art of television signal processing.

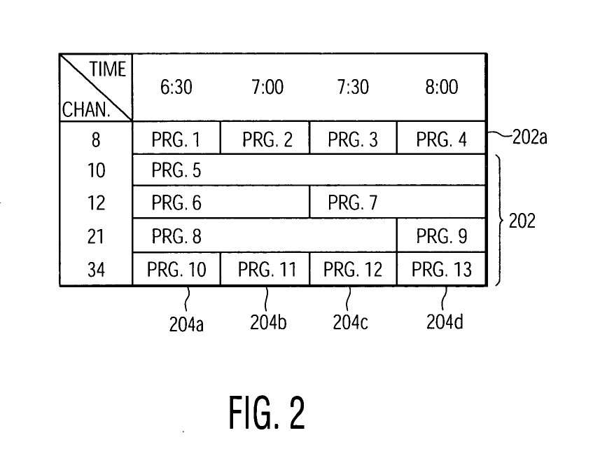

FIG. 2 depicts an exemplary grid pattern 200 of an EPG containing program schedule information. In an exemplary embodiment, the grid pattern 200 is generated by the signal processing device 102 (FIG. 1) for display on the display device 104 (FIG. 1). The illustrated grid pattern includes five rows 202 and four columns 204. The five rows 202 correspond to five program channels and the columns 204 represent periods of time. In the illustrated embodiment, row 202a represents channel 8 and column 204a represents a time period beginning at 6:30 PM and ending at the beginning of the next time period, i.e., 7:00 PM. Thus, in this illustration, program 1 (PRG. 1) is on channel 8 from 6:30 PM to 7:00 PM. Collectively, the four columns 204a-d represent a window of time, e.g., 6:30 PM to 8:30 PM, displayed on the display device 104 (FIG. 1). To select a particular program, a television viewer may use keys/buttons on a control device 106 (FIG. 1) to position a cursor in the row and column corresponding to the desired program. In an exemplary embodiment, the position of the cursor represents the time focus of the grid pattern. For example, when a cursor is positioned on PRG. 12, the grid pattern time focus is 7:30. The position of the cursor may be indicated by a change in color, change in brightness, a change in the width of the border lines, or other methods which distinguish one program cell from the other program cells. In certain exemplary embodiments, when a cell spans multiple columns, the position of the cursor within the cell is identified by different line properties. For example, the entire border of the program cell may be wider than the border of other program cells with dashes around a particular column in which the cursor is positioned. Various other methods for indicating the position of a cursor within the grid pattern will be readily apparent to those of skill in the art of electronic program guides used in television receivers.

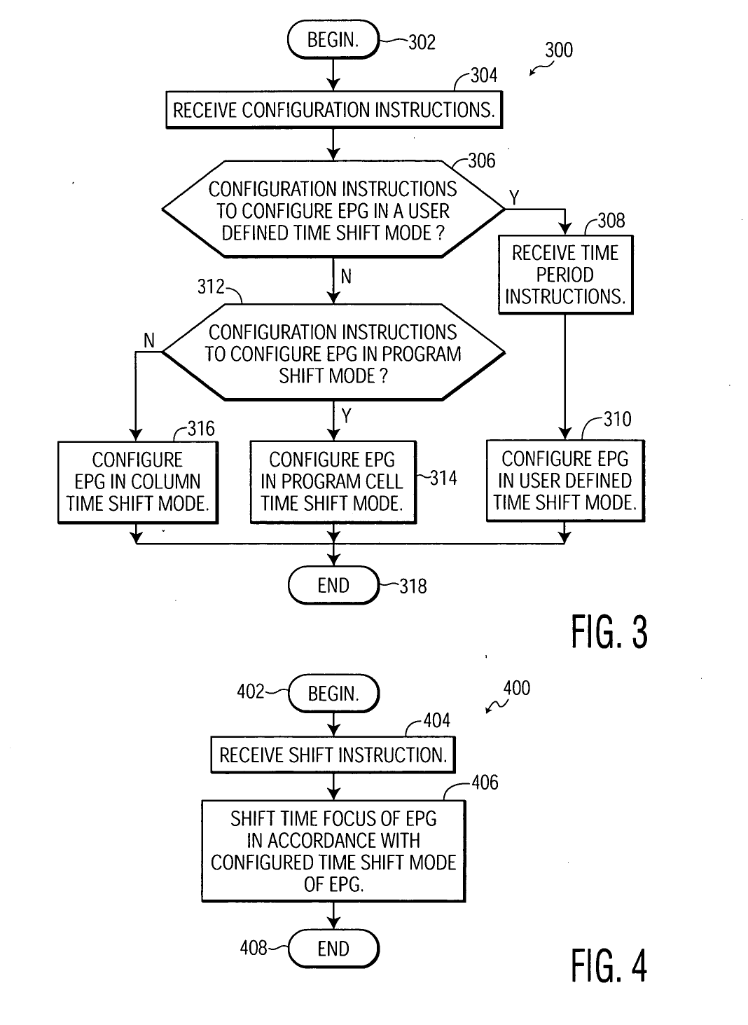

FIG. 3 depicts a flow chart 300 of exemplary steps performed by an EPG controller 119, e.g., controller 118 (FIG. 1), in accordance with the present invention. Processing begins at 302 with the receipt of configuration instruction at block 304. In an exemplary embodiment, the configuration instructions are generated by a control device, e.g., control device 106 (FIG. 1), responsive to key/button presses of a television viewer. In this embodiment, the instructions are passed to the EPG controller 119 of the signal processing device 102, via the user interface 120, for configuration and processing of the EPG controller 119. In certain exemplary embodiments, configuration options are displayed on a display device using a conventional menu such as a drop down menu from which the television viewer may make a configuration selection.

The EPG controller 119 uses the configuration instructions to configure the time shift mode of the EPG controller 119. The time shift mode of the EPG controller 119 specifies how the EPG controller 119 responds to shift instructions for shifting the time focus of the EPG grid pattern. As described above, with reference to FIG. 2, the position of the cursor corresponds to the time focus of the gird pattern. For example, when the cursor is positioned on PRG. 1, the time focus is at 6:30 and when the cursor is on PRG. 9 the time focus is at 8:00. The different modes for time focus shifting specify how the time focus changes in response to shift instructions of a television viewer.

In certain exemplary embodiments, whenever the time focus changes, the displayed portion of the EPG is shifted such that the time focus is always in the left-hand column of the displayed EPG grid pattern. In certain other exemplary embodiments, the time focus may shift within the displayed grid pattern, and the displayed portion only shifts at the edge of the grid pattern. For example, starting with a time focus on PRG. 1 at 6:30, the displayed portion may remain the same as the time focus shifts to PRG. 2 at 7:00 and PRG. 3 at 7:30. However, when the time focus shifts to PRG. 4 at 8:00, the displayed portion may shift such that PRG. 4 at 8:00 now appears in the left most column with future programming displayed to its right. Various other methods for shifting the displayed portion of the EPG in relation to the time focus will be readily apparent to those of skill in the art and are considered within the scope of the present invention.

Referring back to FIG. 3, block 306 through block 316 describe exemplary steps for configuring the time shift mode of the EPG controller 119 based on the configuration instructions received at block 304. The EPG controller 119 is configured in one of at least two time shift modes based on the configuration instructions. By way of non-limiting example, illustrated time shift modes include a user defined time period shift mode, a column time shift mode, and a program cell time shift mode.

In the column time shift mode, the time focus of the grid pattern shifts one column at a time. In this mode, the time focus shifts by the period defined for the column, e.g., a half-hour, regardless of the length of the program cell in which the cursor is presently positioned. For example, referring to FIG. 2, if the cursor is currently positioned in the block displaying PRG. 2, shifting the time focus in a backward direction shifts the time focus to the previous column, e.g., to the block displaying PRG. 1, and shifting the time focus in a forward direction shifts the time focus to the next column, e.g., to the block displaying PRG. 3. Likewise, if the cursor is presently positioned in the block displaying PRG. 8 and is in an area of the block corresponding to the first column 204a, the time focus shifts three times to reach the block displaying PRG. 9. In this example, the first shift of the time focus shifts to the time corresponding to the second column 204b, the second shift of the time focus shifts to the time corresponding to the third column 204c, and the third shift of the time focus shifts to the time corresponding to the fourth column 204d, i.e., the block displaying PRG. 9.

In the program cell time shift mode, the time focus of the grid pattern shifts one program cell at a time. In this mode, the length of the program cell in which a cursor is positioned defines how much the time focus of the EPG shifts. Since program cells have different lengths and, thus, span a different number of columns, the time focus shift is dependent upon the program cell in which the cursor is positioned. For example, referring to FIG. 2, if the cursor is currently positioned in the block displaying PRG. 8, shifting the time focus in a forward direction shifts the time focus to the next program cell, e.g., to the block displaying PRG. 9. Thus, in this example, if each column represent a half hour, the time focus shifts an hour and a half. Likewise, if the cursor is currently positioned in the block displaying PRG. 1, shifting the time focus in a forward direction shifts the time focus to the next program cell, e.g., to the block displaying PRG. 2. In this example, on the other hand, if each column represents a half hour, the time focus shifts only a half hour.

In the user defined time period shift mode, the time focus of the grid pattern shifts one user defined time period at a time. In this mode, the user defines the shift period of the time focus, e.g., twenty minutes, a half hour, hour, hour and a half, etc. Once the user defined time period is defined, a forward/backward shift in the time focus causes the time focus to shift forward/backward by the user defined time period when the EPG controller is configured in this mode. For example, assuming the cursor is presently positioned in the block displaying PRG. 1 and the user defined time period is one hour, shifting the time focus forward shifts the time focus one hour (two columns in the present example) to the time period associated with the block displaying PRG. 3. In another example, assuming the cursor is presently positioned in the block displaying PRG. 13 and the user defined program shift is one hour, shifting the time focus backward shifts the time focus backward one hour, e.g., to the time period associated with the block displaying PRG. 11. In certain exemplary embodiments, the forward shift time period and the backward shift time period are configured separately. For example, the forward shift time period can be set to one hour and the backward shift time period can be set to two hours. This allows the time focus to shift more rapidly in one direction than the other. Thus a user may navigate through the EPG in a forward direction an hour at a time and then quickly return to a previous time, e.g., the current time, in a backward direction two hours at a time.

In certain exemplary embodiments, the user defined time period is engaged only near an edge of the displayed grid pattern. Within the displayed grid pattern, the EPG controller 119 may be configured such that arrow presses advance the time focus of the grid pattern one program cell or one column at a time without changing the displayed grid pattern. At the edge of the displayed grid pattern, arrow presses shift the time focus of the displayed grid pattern by the user defined time period, and the displayed grid pattern changes accordingly.

Referring back to FIG. 3 at block 306, a decision is made to determine if the configuration instructions received at block 304 are instructions to configure the EPG controller in a user defined time period shift mode. If the configuration instructions are instructions to configure the EPG controller in a user defined time period shift mode, processing proceeds to block 308. Otherwise, processing proceeds at block 312.

At block 308, a user defined time period is received. In an exemplary embodiment, the user defined time period is the time associated with one or more columns of the grid pattern. For example, if each column is a half hour, the user defined time period may be selected in increments of a half hour, e.g., a half hour, an hour, an hour and a half, etc. In certain other exemplary embodiments, the user defined time period may be a specified period of time, e.g., twenty minutes, an hour and fifteen minutes, etc. In an exemplary embodiment, the user defined time period is received from a viewer via a control device 106 (FIG. 1).

In exemplary embodiments, a user selects a time period option from a conventional menu such as a drop down menu or enters the time period using a keypad. In embodiments where a different user defined time period can be specified for a forward time shift and a backward time shift, two time periods are specified.

At block 310, the EPG controller is configured in the user defined time period shift mode. In an exemplary embodiment, the EPG controller stores a value indicative of the user defined time period shift mode and the user defined time period, or a value indicative of the user defined time period, in the memory 122 (FIG. 1), for example. Processing then ends at 318.

If the viewer did not select the user defined time period shift mode at block 306, then, at block 312, a decision is made to determine if the configuration instructions received at block 304 are instructions to configure the EPG controller in a program cell time shift mode. If the configuration instructions are instructions to configure the EPG controller in a program cell time shift mode, processing proceeds to block 314. If the configuration instructions are not instructions to configure the EPG controller 119 in a program cell time shift mode, which indicates that the EPG controller 119 should be configured in the column time shift mode in the illustrated embodiment, processing proceeds to block 316.

At blocks 314 and 316, the EPG is configured in the program cell time shift mode and the column time shift mode, respectively. In an exemplary embodiment, the EPG controller stores a value indicative of the program cell time shift mode or the column time shift mode to specify the mode in which the EPG controller is configured. Processing then ends at 318.

FIG. 4 depicts a flow chart 400 of exemplary steps performed by a signal processing device 102 (FIG. 1) to shift the time focus of in EPG grid pattern in accordance with the present invention. Processing begins at block 402 with the receipt of a shift instruction at block 404. In an exemplary embodiment, the signal processing device 102 receives the shift instruction from a control device 106 (FIG. 1). For example, a viewer may press an arrow key 130 of the control device 106 that generates the shift instruction, which is then passed to the signal processing device 102 for processing. In an exemplary embodiment, the shift instruction is either a forward time shift instruction to shift the time focus forward or a backward time shift instruction to shift the time focus to a previous time. In certain exemplary embodiments, the forward time shift instruction is generated by pressing a right arrow button on a control device and the backward time shift instruction is generated by pressing a left arrow button on the control device. The generated time shift instructions are then passed to the controller 118, via the user interface 120, for processing by the controller 118.

At block 406, the signal processing device shifts the time focus of the grid pattern in accordance with the configured shift mode described above with reference to FIG. 3. For example, when configured in the user defined time shift mode, each instruction to shift the time focus shifts the time focus by the appropriate user defined period of time. When configured in the column time shift mode, each instruction to shift the time focus shifts the time focus by one column. When configured in the program time shift mode, each instruction to shift the time focus shifts the time focus by one program cell in which the cursor is positioned. In an exemplary embodiment, the EPG controller retrieves configuration instructions from memory 122 in response to a time shift instruction and modifies the EPG accordingly for display on the display device 104 via the OSD/signal processor 116. Processing then ends at block 408.

In certain exemplary embodiments, a key or key sequence, e.g., pressing a left arrow twice within a predefined period of time (two seconds, for example), prompts the EPG controller to shift/return the time focus to the current time.

Although the components of the present invention have been described in terms of specific components, it is contemplated that one or more of the components may be implemented in software running on a processor. In this embodiment, one or more of the functions of the various components may be implemented in software that controls the processor. This software may be embodied in a computer readable carrier, for example, a magnetic or optical disk, a memory-card or an audio frequency, radio-frequency or optical carrier wave, or other such technology.

Although the invention is illustrated and described herein with reference to specific embodiments, the invention is not intended to be limited to the details shown. Rather, various modifications may be made in the details within the scope and range of equivalents of the claims and without departing from the invention.

1. A method for configuring an electronic program guide controller, the electronic program guide controller capable of generating for display on a display device a electronic program guide grid pattern containing program cells having associated program lengths, the grid including one or more rows and a plurality of columns, wherein each row corresponds to a program channel, each column represents a predefined period of time, and program cells with lengths exceeding the predefined period of time span multiple columns, the method comprising the steps of:
receiving instructions of a user at an electronic program guide controller, the electronic program guide controller capable of being configured in at least two time shift modes, the received instructions for selecting one of the at least two time shift modes; and
configuring the electronic program guide controller in one of the at least two time shift modes responsive to the received instructions.

2. The method of claim 1, wherein the at least two time shift modes include at least two time shift modes selected from a group of time shift modes consisting of a column time shift mode, a program cell time shift mode, and a user defined time period shift mode.

3. The method of claim 1, wherein one of the at least two time shift modes is a column time shift mode and wherein the method further comprises the step of:
receiving shift instructions; and
shifting the grid pattern time focus column by column responsive to the shift instructions when the electronic program guide controller is configured in the column time shift mode.

4. The method of claim 1, wherein one of the at least two time shift modes is a program cell time shift mode and wherein the method further comprises the step of:
receiving shift instructions; and
shifting the grid pattern time focus program cell by program cell responsive to the shift instructions when the electronic program guide controller is configured in the program cell time shift mode.

5. The method of claim 1, wherein one of the at least two time shift modes is a user defined time period shift mode, the received instructions are further for configuring a user defined time period for the user defined time period shift mode, and the method further comprises the step of:
receiving a shift instruction; and
shifting the grid pattern time focus by the user defined time period responsive to the shift instruction when the electronic program guide controller is configured in the user defined time period shift mode.

6. A system for configuring an electronic program guide controller, the electronic program guide controller capable of generating for display on a display device a grid pattern containing program cells having associated program lengths, the grid including one or more rows and a plurality of columns, wherein each row corresponds to a program channel, each column represents a predefined period of time, and program cells with lengths exceeding the predefined period of time span multiple columns, the system comprising:
means for configuring an electronic program guide controller capable of being configured in at least two time shift modes responsive to a configuration signal; and
means for generating the configuration signal responsive to user instructions to select one of the at least two time shift modes.

7. The system of claim 6, wherein one of the at least two time shift modes is a column time shift mode and wherein the system further comprises:
means for receiving shift instructions; and
means for shifting the grid pattern time focus column by column responsive to the shift instructions when the electronic program guide controller is configured in the column time shift mode.

8. The system of claim 6, wherein one of the at least two time shift modes is a program cell time shift mode and wherein the system further comprises:
means for receiving shift instructions; and
means for shifting the grid pattern time focus program cell by program cell responsive to the shift instructions when the electronic program guide controller is configured in the program cell time shift mode.

9. The system of claim 6, wherein one of the at least two time shift modes is a user defined time period shift mode, the received instructions are further for configuring a user defined time period for the user defined time shift mode, and the system further comprises:
means for receiving a shift instruction; and
means for shifting the grid pattern time focus by the user defined time period responsive to the shift instruction when the electronic program guide controller is configured in the user defined time period shift mode.

10. A computer readable medium including software that is configured to control a general purpose computer to implement a method for configuring an electronic program guide controller, the electronic program guide controller capable of generating for display on a display device a grid pattern containing program cells having associated lengths, the grid including one or more rows and a plurality of columns, wherein each row corresponds to a program channel, each column represents a predefined period of time, and program cells with lengths exceeding the predefined period of time span multiple columns, the method comprising the steps of:
receiving instructions of a user at an electronic program guide controller, the electronic program guide controller capable of being configured in at least two time shift modes, the received instructions for selecting one of the at least two time shift modes; and
configuring the electronic program guide controller in one of the at least two time shift modes responsive to the received instructions.

11. The computer readable medium of claim 10, wherein one of the at least two time shift modes is a column time shift mode and wherein the software implemented method further comprises the step of:
receiving shift instructions; and
shifting the grid pattern time focus column by column responsive to the shift instructions when the electronic program guide controller is configured in the column time shift mode.

12. The computer readable medium of claim 10, wherein one of the at least two time shift modes is a program cell time shift mode and wherein the software implemented method further comprises the step of:
receiving shift instructions; and
shifting the grid pattern time focus program cell by program cell responsive to the shift instructions when the electronic program guide controller is configured in the program cell time shift mode.

13. The computer readable medium of claim 10, wherein one of the at least two time shift modes is a user defined time period shift mode, the received instructions are further for configuring a user defined time period for the user defined time period shift mode, and the software implemented method further comprises the step of:
receiving a shift instruction; and
shifting the grid pattern time focus by the user defined time period responsive to the shift instruction when the electronic program guide controller is configured in the user defined time shift mode.

14. An electronic program guide apparatus capable of receiving an electronic program guide signal and generating for display on a display device a grid pattern containing program cells having associated program lengths from the electronic program guide signal, the grid including one or more rows and a plurality of columns, wherein each row corresponds to a program channel, each column represents a predefined period of time, and program cells having a length that exceeds the predefined period of time span multiple columns, the electronic program guide controller comprising:
a controller that receives instructions of a user to select one of at least two time shift modes, the controller configured to receive the electronic program guide signal, to generate the grid pattern from the electronic program guide signal, and to shift the grid pattern time focus responsive to user shift instructions in accordance with the selected one of the at least two time shift modes; and
an on-screen display processor coupled between the controller and the display device, the on-screen display processor being configured to provide the generated grid pattern as a video signal to the display device.

15. The apparatus of claim 14, further comprising:
a transport decoder coupled to the controller, the transport decoder configured to receive the electronic program guide and pass the received electronic program guide to the controller.

16. The apparatus of claim 15, further comprising:
a display device coupled to the on-screen display processor configured to display the video signal.

17. The apparatus of claim 14, wherein the at least two time shift modes include at least two time shift modes selected from a group of time shift modes consisting of a column time shift mode, a program cell time shift mode, and a user defined time period shift mode.

18. The apparatus of claim 14, wherein one of the at least two time shift modes is a column time shift mode in which the grid pattern time focus is shifted column by column responsive to the shift instructions when the column time shift mode is selected.

19. The apparatus of claim 14, wherein one of the at least two time shift modes is a program cell time shift mode in which the grid pattern time focus is shifted program cell by program cell responsive to the shift instructions when the program cell time shift mode is selected.

20. The apparatus of claim 14, wherein one of the at least two time shift modes is a user defined time period shift mode, the controller further receives instructions to configure a user defined time period for the user defined time period shift mode, and the grid pattern time focus is shifted by the user defined time period responsive to the shift instruction when the user defined time period shift mode is selected.
